(19) United States
(12) Patent Application Publication
(10) Pub. No.: US 2011/0315669 A1
(43) Pub. Date: Dec. 29, 2011

(54) SYSTEMS AND METHODS FOR HEATING FLUIDS

(76) Inventor: SHELLY BARLOW, Syracuse, UT (US)

(21) Appl. No.: 12/826,079

(22) Filed: Jun. 29, 2010

(51) Int. Cl. H05B 1/02

(52) U.S. Cl. 219/201; 219/494

(57) ABSTRACT

Systems and methods for heating a fluid having a heating element housing with a heating element to heat a fluid. The heating element housing may include an opening capable of receiving a fluid transporter, e.g., a needle, a syringe, a vial, or an intravenous (IV) tube, among others, that transports the fluid for heating by the heating element. The heating device may also include a power source housing coupled to the heating element housing comprising a power source for providing heat to the heating element. The fluid is heated while flowing through the fluid transporter.

### BACKGROUND OF THE INVENTION

1. Field of the Invention

The present invention relates to systems and methods for heating fluids. In particular the present invention relates to systems and methods for heating medications in liquid form while administering the medication to a patient.

2. Background of the Related Art

In general, liquid medications must remain cold (e.g., refrigerated) prior to being administered to a patient to remain effective and maintain a longer shelf life. If the medication warms up over a period of time, the medication may start to break down and/or deteriorate, becoming less effective than if the medication had remained at a colder temperature. Therefore, it is beneficial to keep the medication cold until it is administered to a patient.

Administering medication at a cold temperature, e.g., below a patient's body temperature, however, is more difficult to administer than administering medication at a warmer temperature, e.g., close to room temperature, or a patient's body temperature. For example, medication at a colder temperature is more difficult to draw out of the container holding the medication, e.g., vial or intravenous (IV) bag or other container, and the medication is also more difficult to administer to a patient, e.g., to inject and/or otherwise insert into a patient. Injecting medication at a colder temperature may shock the patient's body and may also cause the patient to experience more pain from the injection. In addition, injecting medication at a colder temperature into a patient may cause the patient's body to feel cold as the body warms up the medication injected into the body.

In related arts, to administer medication at a warmer temperature, the medication is warmed up in heating ovens or other warming devices prior to administering the medication to a patient. Additionally, patients or medical professionals may leave the medication out at room temperature for a period of time to warm it up before administering the medication. As discussed above, however, allowing medication to warm up over a period of time accelerates the rate in which the medication breaks down and begins to become less effective.

Therefore, there is a need in the art for a device that allows liquid medications to remain at cold temperatures until administered to a patient, without adversely affecting their shelf lives. There is a further need in the art to administer liquid medications at a warm (e.g., room) temperature, so as not to cause inconvenience to the patient by inflicting pain and/or experiencing a chill from the cold medication. There is yet a further need in the art for methods and systems that would permit the medication to remain cold (e.g., refrigerated) until the moment before being injected into the body of a patient, while at the same time being injected into the body of a patient at a warm (e.g., room) temperature.

### SUMMARY OF THE INVENTION

While discussion of the aspects of the present invention that follows uses liquid medication as an illustration, it should be appreciated that the present invention is not limited to medications and may be used in a variety of other situations that involve heating of fluids.

Aspects of the present invention aid users, for example, patients, medical practitioners, doctors and nurses, in administering fluid medication by heating the medication while administering of the medication to a patient.

Aspects of the present invention also include a heating device including a heating element housing and a heating element to heat a fluid. The heating element housing may include an opening for receiving a fluid transporter, e.g., a needle, syringe, vial, or intravenous (IV) tube, among others, through which the fluid to be heated by the heating element flows. The heating device may also include a power source housing coupled to the heating element housing comprising a power source for providing heat to the heating element. In addition, the heating device may include a sensing element that detects the temperature of the heating element and/or the fluid within the heating element and adjusts the amount of power supplied to the heating element based upon the detected temperature.

Additional advantages and novel features relating to the present invention will be set forth in part in the description that follows, and in part will become more apparent to those skilled in the art upon examination of the following or upon learning by practice of aspects of the invention.

### BRIEF DESCRIPTION OF THE DRAWINGS

The present invention will become fully understood from the detailed description given herein below and the accompanying drawings, which are given by way of illustration and example only and thus not limited with respect to aspects of the present invention, wherein:

FIG. 1 is a schematic diagram of a heating device in accordance with an aspect of the present invention;

FIG. 2 is a schematic diagram of a power source housing used with an aspect of the present invention;

FIGS. 3A-3C illustrate examples of heating elements used with aspects of the present invention;

FIG. 4 is a schematic diagram of a heat element housing used with an aspect of the present invention; and

FIG. 5 is a schematic diagram of a needle used with a heating device in accordance with another aspect of the present invention.

### DETAILED DESCRIPTION OF ASPECTS OF THE PRESENT INVENTION

Aspects of the present invention will now be described more fully hereinafter with reference to the accompanying drawings, in which variations and aspects of the present invention are shown. Aspects of the present invention may, however, be realized in many different forms and should not be construed as limited to the variations set forth herein; rather, the variations are provided so that this disclosure will be thorough and complete in the illustrative implementations, and will fully convey the scope thereof to those skilled in the art.

Unless otherwise defined, all technical and scientific terms used herein have the same meaning as commonly understood by one of ordinary skill in the art to which aspects of the present invention belong. The methods and examples provided herein are illustrative only and not intended to be limiting.

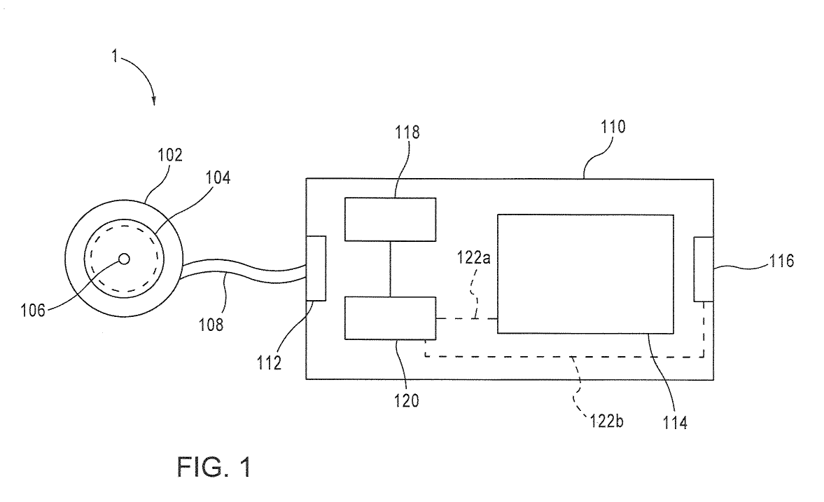

Turning now to FIG. 1, illustrated is a heating device 1 in accordance with an aspect of the present invention. The heating device 1 includes a power source housing 110 with a power source 114, 116 for providing power to a heating element 104. The power source may include, but is not limited to, a battery 114, a socket to receive an external electrical source 116 (e.g., alternating current (AC) power, direct current (DC) battery pack, or a port for charging the battery), fuel cells, and solar power, among other power sources. The power source housing 110 may be a case made out of, for example, plastic, or any other material capable of protecting the power source and remaining cool to the touch on the outside.

The power source housing 110 may also include a sensing element 118 that determines the temperature of the heating element 104 and regulates the amount of power supplied from the power source 114, 116 to the heating element 104. In an aspect, the sensing element 118 may also determine the temperature of the fluid that is being heated by the heating element. The sensing element may include, but is not limited to for example, a temperature sensor, a thermometer, or a thermocouple, among other sensing elements.

In an aspect, the sensing element 118 may transmit a signal representative of the detected temperature to a control circuit 120 coupled to the sensing element 118. The control circuit 120 may receive a signal from the sensing element 118 and may transmit a control signal 122a, 122b to the power source 114, 116. The control signal may include, but is not limited to, a current to increase and/or decrease the amount of power supplied to the heating element 104 based upon the detected temperature, for example.

In accordance with one aspect, if the sensing element 118 determines that the detected temperature is below a predetermined temperature, the sensing element 118 may send a signal to the control circuit 120 to increase the amount of power supplied to the heating element 104. The predetermined temperature may be, for example, a temperature previously established for the specific medication, the patient's body temperature, or any other temperature that is warmer than the temperature of the fluid medication. Moreover, the predetermined temperature may be based upon the type of heating element 104 being used to heat the fluid. For example, some heating elements may heat up more quickly and/or provide more heat than other heating elements. If, however, the sensing element 118 determines that the detected temperature is above a predetermined temperature, then the sensing element may send a signal to the control circuit 120 to decrease the amount of power supplied to the heating element 104 and/or send a signal to the control circuit 120 to shut off the power supply to the heating element 104. Thus, the control circuit 120 may gauge the amount of power supplied to the heating element 104 and assist in changing the power supplied to the heating element 104 via, e.g., a feedback mechanism that increases and/or decreases the amount of power based on the detected temperature.

In addition, the control circuit 120 may include one or more programmable elements, one or more hard wired elements, and a computer processor, among other elements. Moreover, it should also be appreciated that the control circuit 120 may be part of the sensing element 118 and/or separated from the sensing element 118.

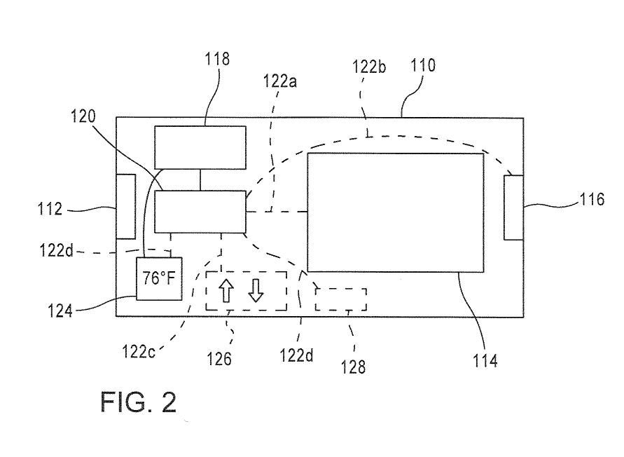

In an optional aspect, as illustrated in FIG. 2, the power source housing 110 may also include a display 124 for displaying the detected temperature, e.g., 76 degrees Fahrenheit, from the sensing element 118. It should also be appreciated that in addition or in lieu of the detected temperature, the temperature of the fluid, e.g., the medication being heated by the heating element 104 and/or the temperature of the heating element 104 may also be displayed.

The power source housing 110 may also include an input device 126 coupled to the control circuit 120 that receives a user's input to control the amount of power supplied to the heating element 104. Input device 126 may be, for example, a display with arrows indicating the change in power, e.g., an up arrow for increasing the amount of power and/or a down arrow for decreasing the amount of power. Moreover, input device 126 may also include, for example, a display with buttons having labels indicating the change in power, e.g., increase, decrease or no change. It should be appreciated that the input device 126 may be any device that is capable of receiving a user's input and sending a control signal 122c to the control circuit 120 based upon the received user's input.

In an aspect, if the displayed temperature 124 is below a predetermined temperature, e.g., a pre-determined temperature for the specific medication, the user may increase the amount of power supplied to the heating element 104 via the input device 126. If, however, the displayed temperature 124 is above the predetermined temperature, the user may decrease the amount of power supplied to the heating element 104 and/or shut off the power supply to the heating element 104. Thus, the user may gauge the amount of power supplied to the heating element 104 and assist in regulating the power supplied to the heating element 104, e.g., increasing and/or decreasing the amount of power based on the displayed temperature.

In an optional aspect, if the detected temperature from the sensing element 118 is above and/or below a predetermined temperature, then the control circuit 120 may send a notification signal 122d to the display 124 and/or a speaker 128 for notifying a user that the detected temperature is above and/or below the predetermined temperature. For example, the notifications may include, but are not limited to, an alarm, a voice recording, changing the color of the displayed temperature, e.g., red for hot and/or blue for cold, or a message displaying the notification, e.g., the temperature is too hot, among other notifications.

Referring again to FIG. 1, the power source housing 110 may further include a port 112 for operationally connecting a heating element housing 102 via a connector 108. The port 112 may allow the heating element housing 102 to plug into the power source housing 110 by providing a power source 114, 116 and a ground to the heating element housing 102. The connector 108 may include, for example, a power chord for supplying the power from the power source 114, 116 and/or thermocouple leads. In addition, the connector 108 may be flexible, such as a flexible insulated wire, or fixed material, such as an insulated wire fixed in place.

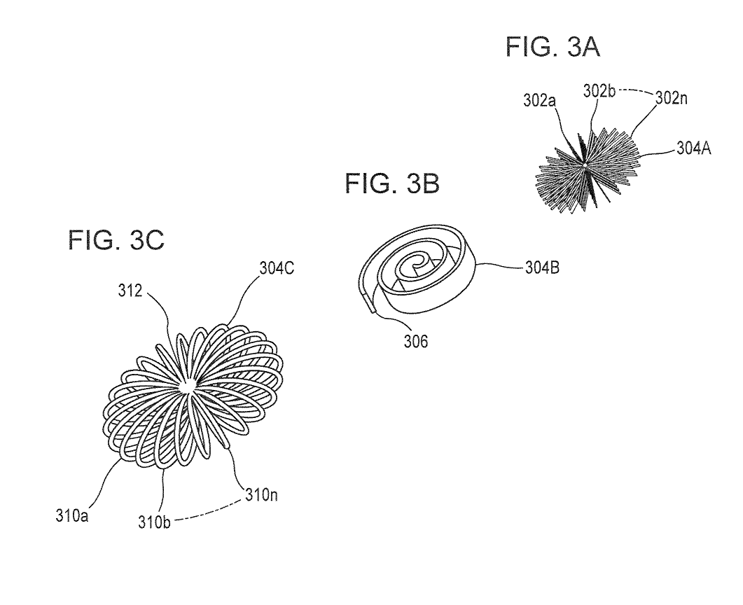

The heating element housing 102 may also include a heating element 104 that receives power from the power supply 114, 116 and converts the received power into heat. The heating element 104 may be constructed of a flexible wire, such as, copper, nichrome 80/20 (80% nickel, 20% chromium), cupronickel (CuNi), or an insulated wire, among other materials that are able to heat up quickly upon receiving power. In addition, the heating element 104 may be implemented in various shapes and/or sizes, as illustrated in FIGS. 3A-3C, to accommodate various shapes and sizes of a fluid transporter. A fluid transporter may include, but is not limited to, a needle, a syringe, a tube, an intravenous (IV) tube, or a vial of liquid medication, among other containers capable of holding a fluid. The heating element 104 converts the received power from the power supply 114, 116 and heats the fluid within the fluid transporter. It should be appreciated that the heating element 104 may expand and/or contract to accommodate the various shapes and/or sizes of the fluid transporters.

Turning now to FIGS. 3A-3C, illustrated are various examples of heating elements 304a-304c that may be used with an aspect of the present invention. One variation includes heating element 304a with multiple fingers 302a-302n pointing into a center 304. The multiple fingers 302a-302n in heating element 304a provide multiple surfaces of contact between the heating element 304a and the fluid transporter, e.g., a needle. Thus, the heat may be transferred from the heating element 304a to the needle via the multiple fingers 302a-302n.

Another variation includes heating element 304b with a flexible coil of material 306, e.g., a wire as discussed above in reference to FIG. 1. A fluid transporter, e.g., a needle, may be inserted through the coil of material 306. As the coil of material 306 comes into contact with the needle, the heat may be transferred from the coil of material 306 to the fluid transporter, thus heating the fluid contained in the fluid transporter.

Yet another variation includes heating element 304c with a flexible coil of material 308 that expands to fit various sizes of fluid transporters, e.g., needles or IV tubes. The heating element 304c includes multiple circular or oval-shaped fingers, or fingers of any other appropriate shape, 310a-310n of flexible material extending from the center 312 of heating element 304c, e.g., a spiral coil with a number of loops surrounding the center. Thus, heat may be transferred from the multiple circular or oval-shaped fingers 310a-310n to the needle, heating the fluid in the fluid transporter.

It should be appreciated that the greater the amount of surface area of the heating element in contact with the fluid transporter, the faster the heat may be transferred from the heating element to the fluid in the fluid transporter. Moreover, it should also be appreciated that the size of the various heating elements 304a-304c may be adjustable based on the expected use, e.g., larger sizes for vials of medication, syringes and tubing for IVs, and/or smaller sizes for needles.

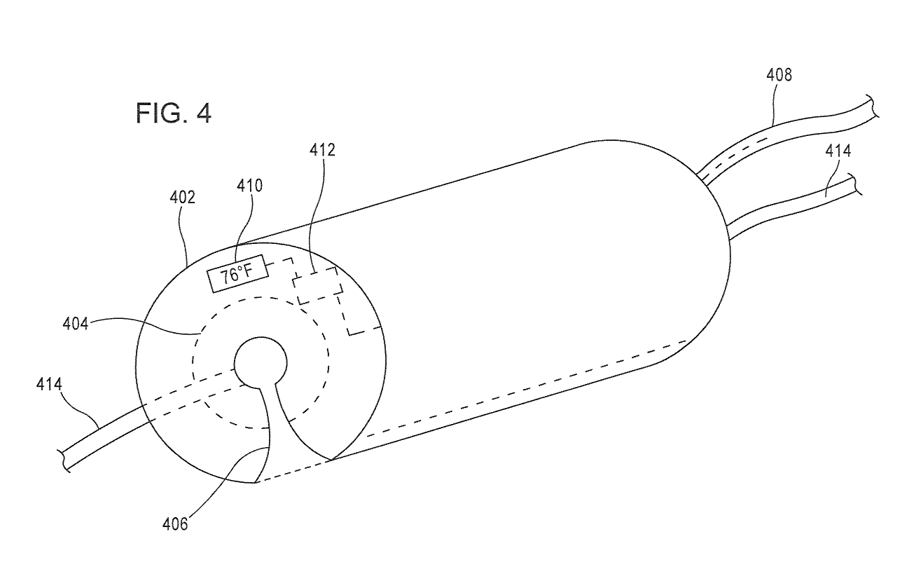

Referring again to FIG. 1, the heating element housing 102 also includes an opening 106 for receiving one or more fluid transporters, such as a needle, for the heating element 104 to heat the fluid contained within the fluid transporter. The opening 106 may be of various shapes and/or sizes and/or may be adjustable to accommodate different fluid transporters, e.g., circle, oval, square, rectangle, octagon, or a slot, among other shapes/sizes. Moreover, the opening 106 may also expand and/or contract to accommodate different sizes and/or shapes of the fluid transporters. For example, a slot opening, as illustrated in FIG. 4, may allow the IV line to longitudinally slide into the heating element 104.

Turning now to FIG. 4, illustrated is an example heating element housing 402 used with an aspect of the present invention. Heating element housing 402 includes a heating element 404, and a slot opening 406, and a connector 408 as discussed above in regards to FIG. 1. The slot opening 406 may allow an IV line 414 to longitudinally slide towards the center of the heating element housing 402. Thus, the heating element 404 may surround the IV line 414 while heating the fluid flowing through the IV line 414.

In an optional aspect, heating element housing 402 may also include a sensing element 412 that determines the temperature of the heating element 404. The sensing element 412 may include, for example, a temperature sensor, a thermocouple, and thermometer, among other sensing elements. The sensing element 412 may also determine the temperature of the fluid, e.g., the medication, within the fluid transporter. The sensing element 412 may transmit the detected temperature to a display 410 for displaying the detected temperature, e.g., 76 degrees Fahrenheit. In addition, the sensing element 412 may transmit the detected temperature to the control circuit 120 (FIG. 1) for use in controlling the amount of power supplied to the heating element 404 as discussed above in regards to FIG. 1. It should be appreciated that the notifications, as discussed above in reference to FIG. 2, may be used in conjunction with the display 410, e.g., notifications alerting the user that the detected temperature is higher or lower than a pre-determined temperature.

Referring again to FIG. 1, the material of the heating element housing 102, is such that while the heating element 104 is heating up on the inside, the outside of the heating element housing 102 does not heat up, e.g., a user is capable of holding the heating element housing in the user's hand while the heating element is warming the fluid in the fluid transporter. The heating element housing 102 may be made from, for example, plastic, or a flexible material that expands based on various shapes and/or sizes, among other materials.

It should also be appreciated that heat element housings of various types and/or sizes may be connected to the power source housing 110 via the port 112. For example, the heat element housing 102 may be one size for accommodating needles and a different size to accommodate vials of medication, syringes, IV bags and/or tubes for IVs. Moreover, the heat element housing 102 may also be various shapes, such as but not limited to for example, a circle, an oval, an octagon, a square, a disk, or a sphere, among other shapes, and may also be adjustable.

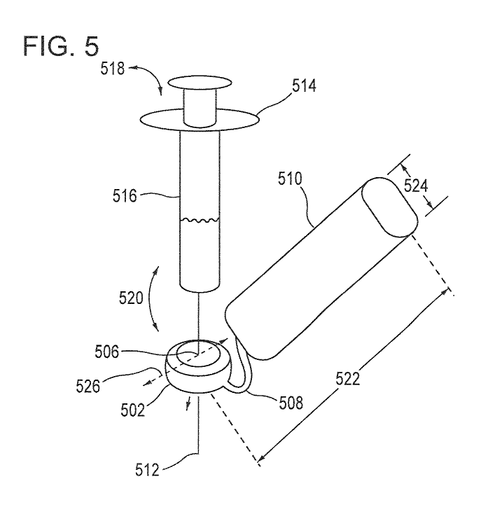

Turning now to FIG. 5, illustrated is an example needle 512 in use with a heating device 2 in accordance with an aspect of the present invention. It should be appreciated that heating device 2 has similar functionality as the heating device 1 discussed above in relation to FIG. 1, e.g., a heating element housing 502 coupled to a power source housing 510 via a connector 508.

In operation, the heating element housing 502 receives one or more needles 512 trough an opening 506 and heats the fluid contained within the needle 512 using the heating element 104 (FIG. 1). A user, e.g., a medical professional or a patient, may apply a force 518 on a syringe 514 coupled to the needle 512 while holding the power supply housing 510 in the user's hand. The force 518 may draw a fluid 516, e.g., various types of liquid medication, water, or saline, among other fluids, from a container holding the fluid through the needle 512 into the syringe 514. As the fluid 516 moves through the needle 512, in a direction 520 towards the syringe, the heating element 104 (FIG. 1) heats the fluid contained within the needle 512. Thus, the fluid moving through the needle is heated while the remaining fluid in the container remains at or very close to the temperature of the fluid prior to heating. The heated fluid 516 may then be injected and/or inserted into a patient.

Alternatively or in addition, the force 518 may move the fluid 516 in a direction 520 from the syringe 514 to the needle 512. As the fluid 516 moves into the needle 512 from the syringe, the heating element 104 (FIG. 1) heats the fluid contained within the needle 512. Thus, the fluid is heated while the fluid is being injected and/or inserted into the patient.

The heating device 2 illustrated in this example may be portable, e.g., handheld. The dimensions of the heating device 2 in accordance with an aspect may include, for example, a length 522 from a first end of the power supply housing 510 to the middle of the heating element housing 502, such as 2.5 inches. Moreover, the dimensions of the heating device 2 may include, for example, a width 524 of the power supply housing 510, such as 0.375 inches. In addition, the diameter 526 of the heating element housing 502 may be, for example, 0.5 inches. It should be appreciated that these measurements are illustrative of an aspect of the present invention and that various shapes and/or sizes of the heating device are within the scope of the present invention.

For example, one variation of the present invention may include the heating device for use in field conditions. Field conditions may include, for example, search and rescues, third world countries, military medical stations, at sea, while hiking, traveling medical stations, or any location where liquid medication may need to be administered to a patient and power may not be readily available. Thus, the heating device according to this variation may be portable, e.g., handheld and run on battery power and/or solar power, among other portable power sources.

Another variation of the present invention may include a heating device for use in a hospital setting with the availability of power and space to heat the fluid. Thus, the heating device may be a larger size for resting on a surface, e.g., a table top or a bedside table, and capable of heating a larger volume of fluid. Thus, it should be appreciated that the sizes of the heating devices of aspects of the present invention may be based upon the types of fluid transporters transporting the fluid to be heated and/or the location or intended use.

Although the invention has been described with reference to various aspects of the present invention and examples with respect to liquid medications, it is within the scope and spirit of the invention to incorporate or use it for any fluid with any suitable heating device. Further, while the invention has been described with reference to medical professionals and/or patient users, the invention may be used by other users depending on circumstances in which the invention is used. Thus, it should be understood that numerous and various modifications may be made without departing from the spirit of the invention.

What is claimed is:

1. A heating device, comprising:
a heating element having a housing, the housing comprising an opening for receiving a fluid transporter; and
a power source having a housing coupled to the heating element housing, the power source being operable to regulate the heating element;
wherein the heating element is operable to heat the fluid in the fluid transporter while the fluid is flowing through the transporter.

2. The heating device of claim 1, wherein the fluid transporter is one of a needle, a syringe, a vial, a tube, an intravenous (IV) bag, an IV line, or any combination thereof.

3. The heating device of claim 1, further comprising:
a sensing element operable to detect a temperature of the heating element; and
a control circuit operable to adjust the amount of power supplied to the heating element;
wherein the sensing element compares the detected temperature to a predetermined temperature and the control circuit adjusts the amount of power supplied to the heating element based on the comparison.

4. The heating device of claim 3, wherein the power source decreases the amount of power supplied to the heating element.

5. The heating device of claim 3, wherein the power source increases the amount of power supplied to the heating element.

6. The heating device of claim 3, wherein the sensing element is further operable to detect the temperature of the fluid.

7. The heating device of claim 3, further comprising:
a display operable to display the detected temperature.

8. The heating device of claim 1, wherein the heating element further comprises:
a sensing element operable to detect the temperature of the heating element.

9. The heating device of claim 8, wherein the sensing element is further operable to detect the temperature of the fluid.

10. The heating device of claim 9, further comprising:
a display operable to display the detected temperature.

11. The heating device of claim 1, wherein the power source comprises a battery, alternating current (AC), direct current (DC), fuel cells, solar power, or any combination thereof.

12. The heating device of claim 1, wherein the heating element comprises a flexible coil.

13. The heating device of claim 1, wherein a shape of the opening in the heating element housing is one of a circle, an oval, or a slide.

14. The heating device of claim 1, wherein the power source housing is connected to the heating element housing via a flexible connection.

15. A method of heating a fluid, comprising:
inserting a fluid transporter through an opening in a heating element;
receiving, via the fluid transporter, a fluid from a container; and
heating, via the heating element, the fluid in the fluid transporter while the fluid is flowing through the transporter;
wherein a power source coupled to the heating element regulates the amount of power supplied to the heating element.

16. The method of claim 15, wherein the fluid transporter is one of a needle, a syringe, a vial, a tube, an intravenous (IV) bag, an IV line, or any combination thereof.

17. The method of claim 15, further comprising:
detecting a temperature of the heating element; and
comparing the detected temperature to a predetermined temperature; and
adjusting the amount of power supplied to the heating element;
wherein the adjusting is based on the comparison.

18. The method of claim 17, wherein the adjusting decreases the amount of power supplied to the heating element.

19. The method of claim 17, wherein the adjusting increases the amount of power supplied to the heating element.

20. A system for heating a fluid, comprising:
means for inserting a fluid transporter through an opening in a heating element;
means for receiving, via the fluid transporter, a fluid from a container; and
means for heating, via the heating element, the fluid in the fluid transporter while the fluid is flowing through the transporter;
wherein a power source coupled to the heating element regulates the amount of power supplied to the heating element.
